(19) United States
(12) Patent Application Publication
(10) Pub. No.: US 2011/0299740 A1
(43) Pub. Date: Dec. 8, 2011

(54) BIOMETRIC AUTHENTICATION UNIT

(75) Inventor: HIROKAZU MORI, Owariasahi (JP)

(73) Assignee: Hitachi-Omron Terminal Solutions, Corp.

(21) Appl. No.: 13/152,100

(22) Filed: Jun. 2, 2011

(30) Foreign Application Priority Data
Jun. 3, 2010 (JP) 2010-128102

(51) Int. Cl. G06K 9/00

(52) U.S. Cl. 382/115

(57) ABSTRACT

A biometric authentication unit includes a position detecting section for detecting a user's finger position from a pressure distribution detected by a right-side pressure detecting plate, a left-side pressure detecting plate, a front-side pressure detecting plate, a rear-side pressure detecting plate and a fingertip pressure detecting plate; corrects a finger vein pattern of a registrant data on the basis of the difference between the detected user's finger position and a correct position; collates the acquired user's finger vein pattern with the corrected registrant data; and authenticates whether the user is the registrant.

### INCORPORATION BY REFERENCE

The present application claims priority from Japanese application JP2010-128102 filed on Jun. 3, 2010, the content of which is hereby incorporated by reference into this application.

### BACKGROUND OF THE INVENTION

The present invention relates to a biometric authentication unit for collating a finger vein pattern acquired from a finger image of a person to be authenticated taken by a imaging section with a previously registered finger vein pattern of a registrant to authenticate whether the person is the registrant.

In the past, the biometric authentication unit for authenticating users has been used in various devices and systems by using biometric information. For example, the biometric authentication unit has been used in automated teller machines (ATM) installed at banking facilities so as to authenticate whether the user who intends to make an ATM transaction is an account holder. Further, in an entering and leaving management system for managing persons who enter or leave a specific location such as a security room, the biometric authentication unit has also been used for authenticating whether the user is a person who is permitted to enter or leave the location. The biometric information used for authenticating the user includes a finger vein, finger pattern, palm pattern, iris, etc.

The biometric authentication collates the biometric information acquired from the user with the previously registered biometric information of the registrant to authenticate that the user is the registrant if a degree of similarity between them exceeds a predetermined threshold value. In the biometric authentication, the biometric information of the user is acquired from an mage of the user's specific region (determined by the biometric information used for authentication) taken by the imaging section. The biometric information of previously acquired from the image of the registrant's specific region taken by the imaging section is also registered as master data.

The biometric information acquired from the image taken by the imaging section varies with an angle variation to the specific region of the imaging section. In contrast, it is realistically impossible to match perfectly the angles to the specific region when registering and authenticating. Consequently, JP-A-2008-134862 has proposed a technique for securing the accuracy of authenticating a user, that is, for collating the finger vein pattern acquired from the user's image taken by the imaging section with the registrant's finger vein pattern by using a feature quantity for winkle of the user's finger joint. Specifically, it is detected whether the location of a user's finger placed on a stage is shifted to the front or rear, or to the left or right by using the winkle of the finger joint when authenticating at this time, in comparison with the location of the finger placed on the stage when registering the finger vein pattern. The registrant registers not only the registrant's finger vein pattern but also the winkle pattern of the registrant's finger joint. When collating the user's finger vein pattern acquired from the image taken by the imaging section with the registrant's finger vein pattern, either the user's finger vein pattern or the registrant's finger vein pattern is corrected depending on a detected shift amount of the finger location between when registering and authenticating.

### SUMMARY OF THE INVENTION

In JP-A-2008-134862, the accuracy of authentication can be secured if the location of the finger placed on the stage when authenticating at this time is shifted to the front or rear, or to the left or right from the location of the finger placed on the stage when registering the finger vein pattern. However, the accuracy of authentication cannot be secured if the finger placed on the stage is slanted or rotated.

An object of the invention is to provide a biometric authentication unit which detects the finger position on the stage of an person to be authenticated to authenticate an identical person on the basis of the finger vein pattern by using the detected finger position, and to sufficiently prevent from lowering the accuracy of authentication.

The biometric authentication unit according to the invention comprises the following configurations to solve the above-mentioned problem and achieve the object.

An imaging section takes through an opening an finger image of an person to be authenticated, the finger being placed opposed to the opening. A position detecting section detects by a plurality of sensors arranged around the opening a finger position of the person to be authenticated, the finger being placed opposed to the opening. The position detecting section has the plurality of sensors arranged around the opening to detect the presence or absence of the person's finger from detected results of the sensors. For example, the sensor may be a piezoelectric sensor for detecting a suppress strength, an optical sensor for detecting the presence or absence of a transmitted light and reflected light, a capacitance sensor for detecting a capacitance variation, etc. The plurality of sensors may be arranged so as to detect the finger position of the user.

The authenticating unit collates a finger vein pattern acquired from a finger image of an person to be authenticated taken by the imaging section with a previously registered finger vein pattern of a registrant to authenticate whether the person to be authenticated is the registrant. Specifically, either the previously registered finger vein pattern of the registrant or the finger vein pattern acquired from the finger image of the person to be authenticated taken by the imaging section is corrected depending on the detected position so that both the finger vein pattern of the registrant and the finger vein pattern of the person to be authenticated can be acquired at the substantially same angle. Therefore, the biometric authentication is implemented so as to suppress an effect caused by a difference between the user's finger positions when registering and authenticating, and to sufficiently prevent from lowering the accuracy of authentication.

The biometric authentication unit comprises a control section for determining on the basis of the finger position of the person to be authenticated detected by the position detecting section whether the finger image of the person to be authenticated taken by the imaging section is inappropriate for the authenticating section that uses the finger image to authenticate whether the person is the registrant, before the imaging section takes through the opening the finger image of the person to be authenticated. An I/O section may also output an instruction for correcting the position when the control section determines that the finger image is inappropriate for the authenticating section that uses the finger image to authenticate whether the person is the registrant.

The above-mentioned configuration prevent from taking wasted images and increasing a process time to authenticate whether the person to be authenticated is the registrant.

The invention can sufficiently prevent from lowering the accuracy of authenticating an identical person on the basis of the finger vein pattern.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of a major portion in a biometric authentication unit.

FIG. 2 is a top view of the biometric authentication unit.

FIG. 3 is a side section view of the biometric authentication unit.

FIG. 4 is a front view of the biometric authentication unit.

FIG. 5 is a diagram showing an example of a finger position in the biometric authentication unit.

FIG. 6 is a diagram showing a pressure distribution detected by pressure detecting plates.

FIG. 7 is a diagram showing an exam pie of a finger position in the biometric authentication unit.

FIG. 8 is a diagram showing a pressure distribution detected by the pressure detecting plates.

FIG. 9 is a diagram showing an example of a finger position in the biometric authentication unit.

FIG. 10 is a diagram showing a pressure distribution detected by the pressure detecting plates.

FIG. 11 is a diagram showing an example of a finger position in the biometric authentication unit.

FIG. 12 is a diagram showing a pressure distribution detected by the pressure detecting plates.

FIG. 13 is a diagram showing an example of a finger portion in the biometric authentication unit.

FIG. 14 is a diagram showing a pressure distribution detected by the pressure detecting plates.

FIG. 15 is a diagram showing an example of a finger position in the biometric authentication unit.

FIG. 16 is a diagram shoeing a pressure distribution detected by the pressure detecting plates.

FIG. 17 is a diagram showing an example of a finger position in the biometric authentication unit.

FIG. 18 is a diagram showing a pressure distribution detected by the pressure detecting plates.

FIG. 19 is a diagram showing an example of a finger position in the biometric authentication unit.

FIG. 20 is a diagram showing a pressure distribution detected by the pressure detecting plates.

FIG. 21 is a diagram showing an example of a finger position in the biometric authentication unit.

FIG. 22 is a diagram showing a pressure distribution detected by the pressure detecting plates.

FIG. 23 is a flowchart showing an operation of the biometric authentication unit.

FIG. 24 is a diagram showing a screen example in an error process.

### DETAILED DESCRIPTION OF THE EMBODIMENTS

Hereinafter, embodiments of a biometric authentication unit according to the invention be described.

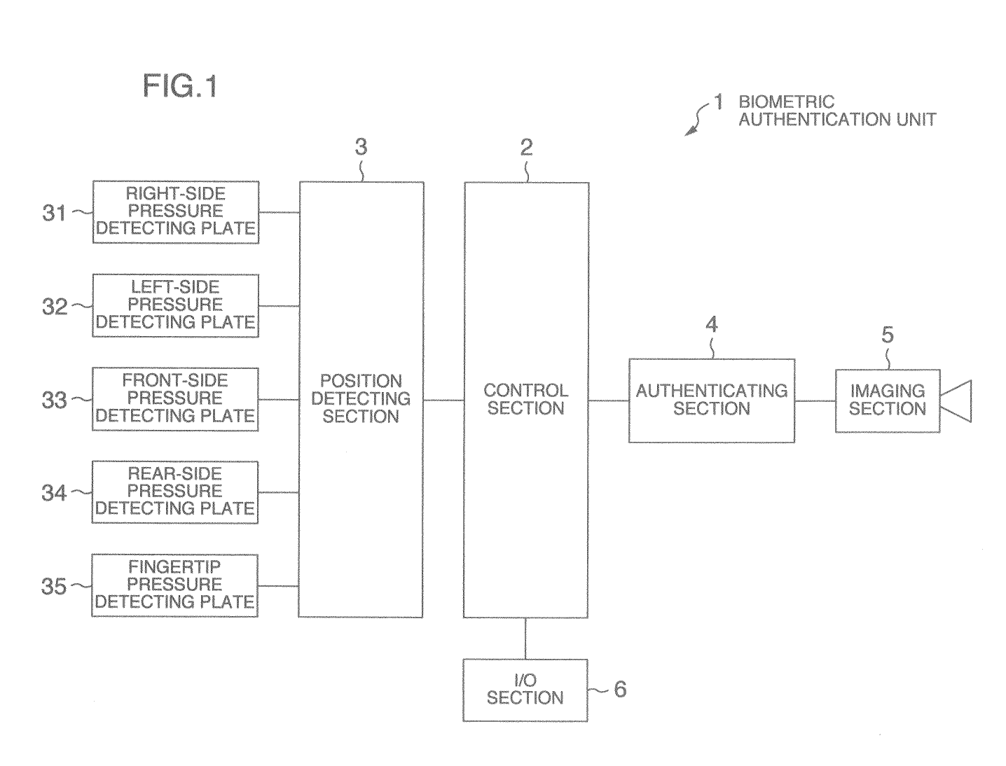

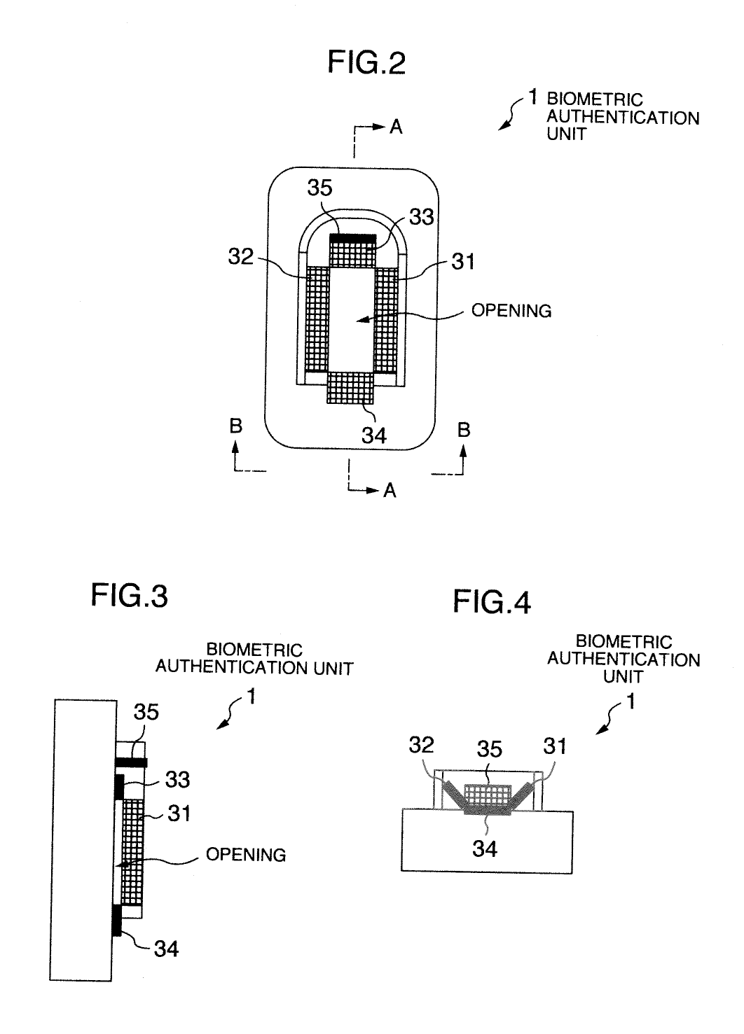

FIG. 1 is a block diagram showing a configuration of a main portion in the biometric authentication unit. FIG. 2 is a top view of the biometric authentication unit. FIG. 3 is a side section view indicated by an arrow A-A shown in FIG. 2. FIG. 4 is a front view indicated by an arrow B-B shown in FIG. 2.

The biometric authentication unit 1 comprises a control section 2, a position detecting section 3, an authenticating unit 4, a imaging section 5 and an I/O section 6. The biometric authentication unit 1, by using a finger vein pattern of a person to be authenticated (hereinafter, referred to as a user), authenticates whether the user is a registrant. The biometric authentication unit 1 is also applicable to automated teller machine (ATM) installed at banking facilities, an entering and leaving management system for managing users who enter or leave a security room, etc.

The control section 2 controls operations of respective sections of the entire biometric authentication unit 1.

The position detecting section 3 detects a user's finger position on a stage. The position detecting section 3 is connected with a right-side pressure detecting plate 31, a left-side pressure detecting plate 32, a front-side pressure detecting plate 33, a rear-side pressure detecting plate 34 and a fingertip pressure detecting plate 35. Each of the right-side pressure detecting plate 31, left-side pressure detecting plate 32, front-side pressure detecting plate 33, rear-side pressure detecting plate 34 and fingertip pressure detecting plate 35 is configured so that a plurality of piezoelectric sensors are arranged in a matrix. Each of the right-side pressure detecting plate 31, left-side pressure detecting plate 32, front-side pressure detecting plate 33, rear-side pressure detecting plate 34 and fingertip pressure detecting plate 35 inputs the outputs of its piezoelectric sensors to the position detecting section 3.

The right-side pressure detecting plate 31, left-side pressure detecting plate 32, front-side pressure detecting plate 33 and rear-side pressure detecting plate 34 are also arranged around an opening formed on the stage. The fingertip pressure detecting plate 35 is arranged almost vertically so that a fingertip hits against it. The position detecting section 3 detects the user's finger position on the stage by sensing an area (pattern) in each of the right-side pressure detecting plate 31, left-side pressure detecting plate 32, front-side pressure detecting plate 33, rear-side pressure detecting plate 34 and fingertip pressure detecting plate 35, the user's finger hitting against and presses the area.

The imaging section 5 has an infrared camera for taking a vein image of the user's finger placed on the stage. Prisms (not shown) are arranged underneath the opening of the stage surrounded by the right-side pressure detecting plate 31, left-side pressure detecting plate 32, front-side pressure detecting plate 33 and rear-side pressure detecting plate 34. The imaging section 5 takes an inner surface image of the user's finger by using the prisms, the inner surface being opposed to the opening.

The I/O section 6 controls an I/O operation with a high-level device. The finger vein pattern of the registrant is input from the high-level device to I/O section 6. The I/O section 6 also notifies an authentication result of the user to the high-level device.

The authenticating unit 4 collates the finger vein pattern of the user with that of the registrant to authenticate whether the user is the registrant. The finger vein pattern of user is acquired from the inner surface image of the user's finger taken by the imaging section 5. The finger pattern of registrant is also acquired from the high-level device through the I/O section 6. For example, assuming that the high-level device is ATM, the ATM reads the registrant's finger vein pattern recorded in a cache-card inserted into it to input it to the I/O section 6.

Next, it will be explained specifically how the position detector 3 detects the user's finger position on the stage.

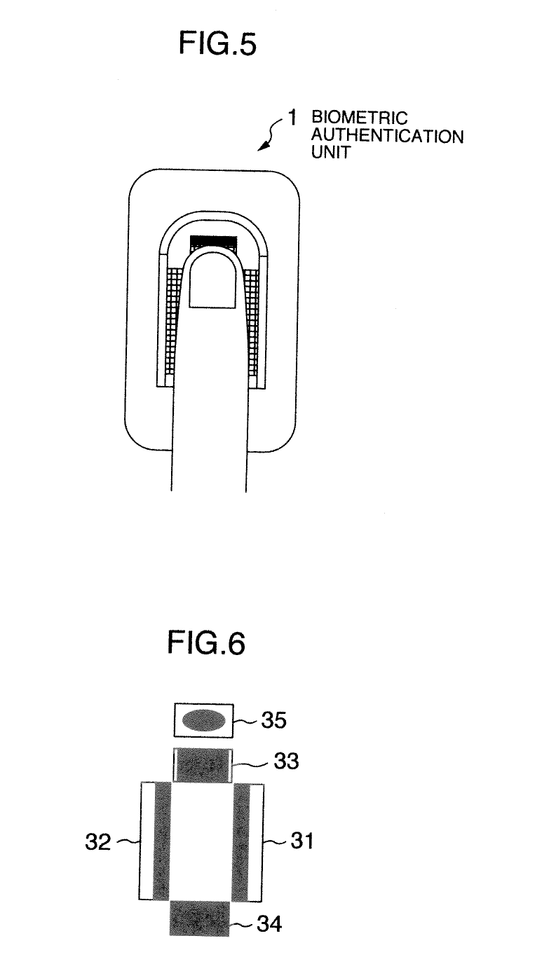

FIG. 5 shows a user's correct finger position on the stage. Specifically, FIG. 5 shows a condition where the fingertip of finger extended substantially straight presses the fingertip pressure detecting plate 35. The inner surface of finger also presses the right-side pressure detecting plate 31, left-side pressure detecting plate 32, front-side pressure detecting plate 33 and rear-side pressure detecting plate 34. The user's finger is placed on a substantially center position between the right-side pressure detecting plate 31 and left-side pressure detecting plate 32, and is extended substantially in parallel to the right-side pressure detecting plate 31 and left-side pressure detecting plate 32. FIG. 6 shows a pressure distribution detected by the right-side pressure detecting plate 31, left-side pressure detecting plate 32, front-side pressure detecting plate 3 rear-side pressure detecting plate 34 and fingertip pressure detecting plate 35. In FIG. 6, blacked-out portions show areas where a suppress strength applied by the user's finger is detected.

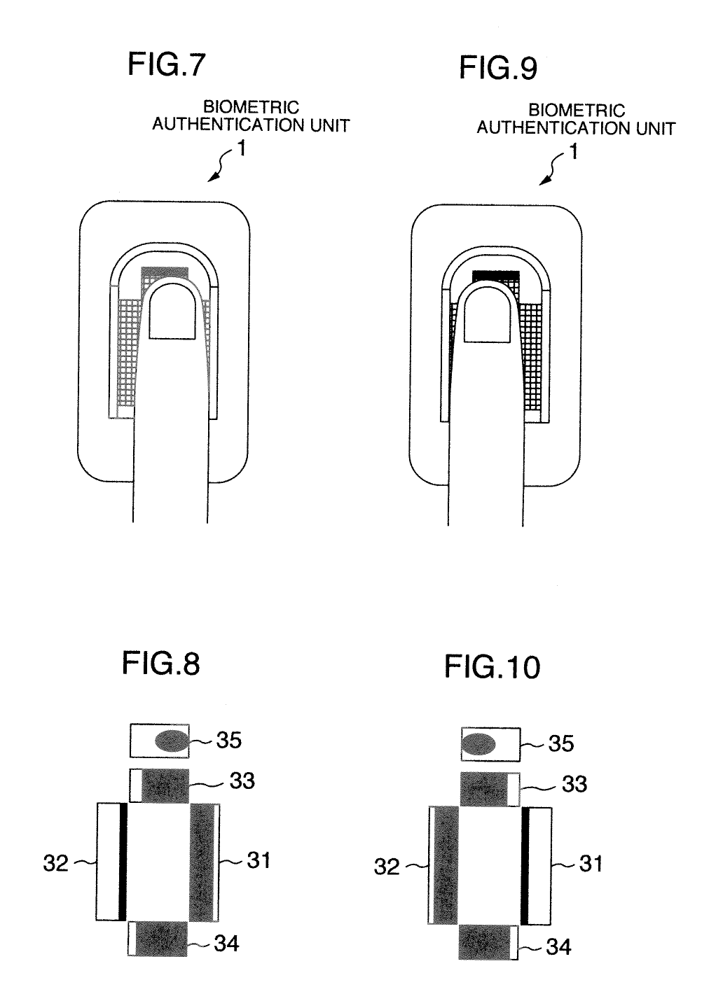

FIG. 8 shows a pressure distribution detected by the right-side pressure detecting plate 31, left-side pressure detecting plate 32, front-side pressure detecting plate 33, rear-side pressure detecting plate 34 and fingertip pressure detecting plate 35, when the user's finger placed on the stage is shifted to the right shown in FIG. 7. FIG. 10 shows a pressure distribution detected by the right-side pressure detecting plate 31, left-side pressure detecting plate 32, front-side pressure detecting plate rear-side pressure detecting plate 34 and fingertip pressure detecting plate 35, when the user's finger is shifted to the left from a correct position in FIG. 5 as shown in FIG. 9.

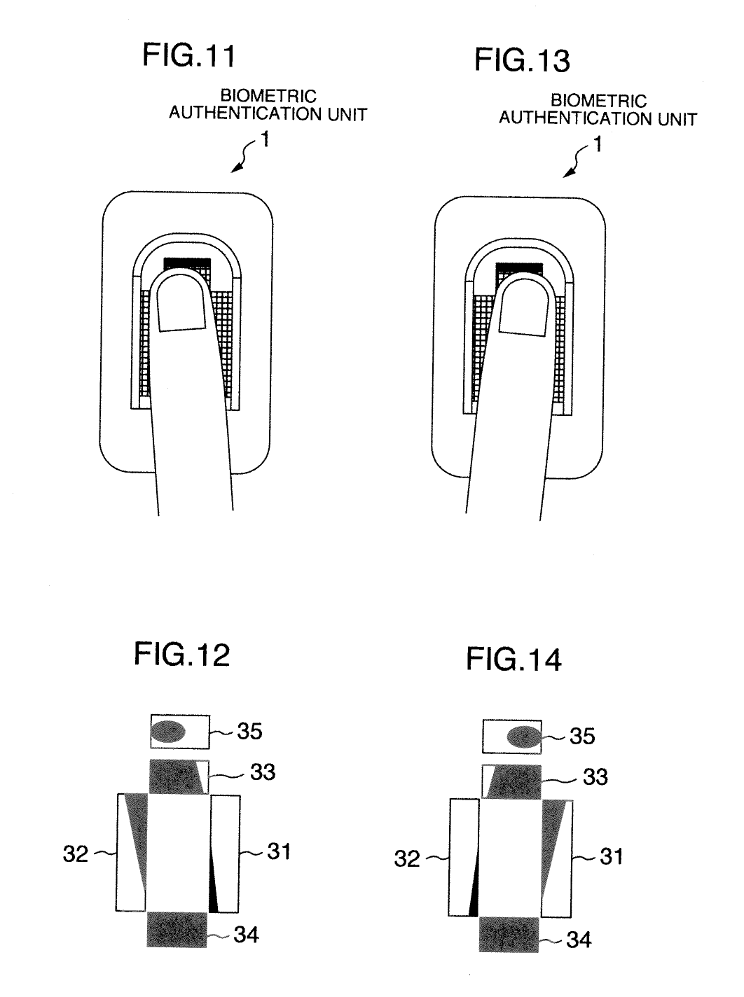

FIG. 12 shows a pressure distribution detected by the right-side pressure detecting plate 31, left-side pressure detecting plate 32, front-side pressure detecting plate 33, rear-side pressure detecting plate 34 and fingertip pressure detecting plate 35 when the user's finger placed on the stage is slanted to the right as shown in FIG. 11. FIG. 14 shows a pressure distribution detected by the right-side pressure detecting plate 31, left-side pressure detecting plate 32, front-side pressure detecting plate 33, rear-side pressure detecting plate 34 and fingertip pressure detecting plate 35, when the user's finger placed on the stage is slanted to the left as shown in FIG. 13.

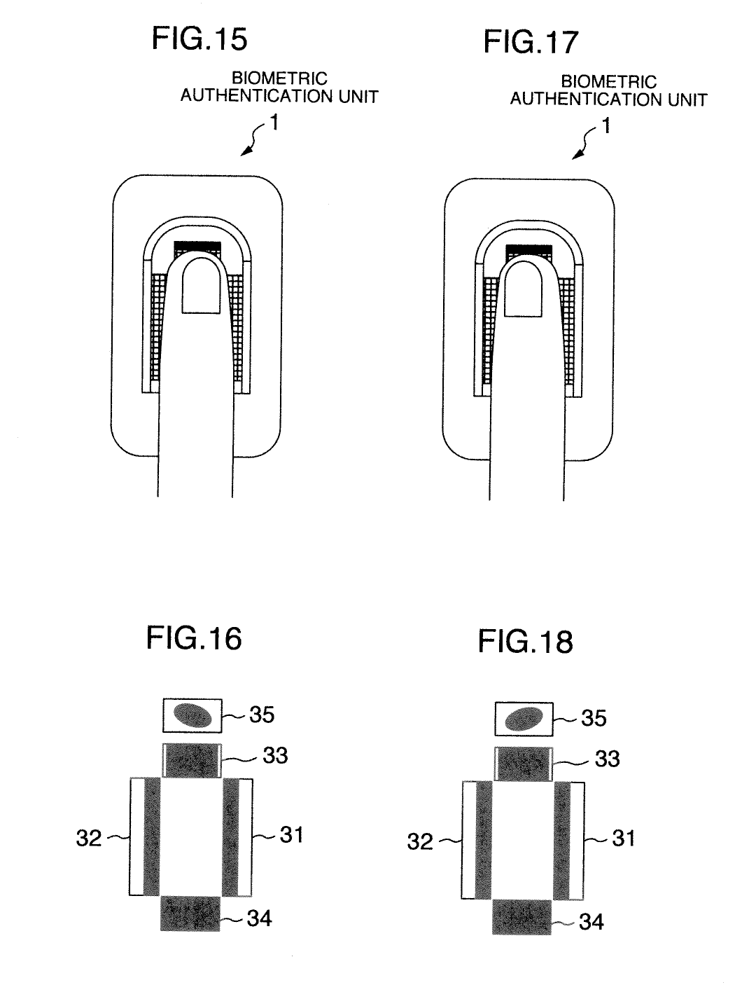

FIG. 16 shows a pressure distribution detected by the right-side pressure detecting plate 31, left-side pressure detecting plate 32, front-side pressure detecting plate 33, rear-side pressure detecting plate 34 and fingertip pressure detecting plate 35, when the user's finger placed on the stage is rotated to the right as shown in FIG. 15. FIG. 18 shows a pressure distribution detected by the right-side pressure detecting plate 31, left-side pressure detecting plate 32, front-side pressure detecting plate 33, rear-side pressure detecting plate 34 and fingertip pressure detecting plate 35, when the user's finger placed on the stage is rotated to the left as shown in FIG. 17.

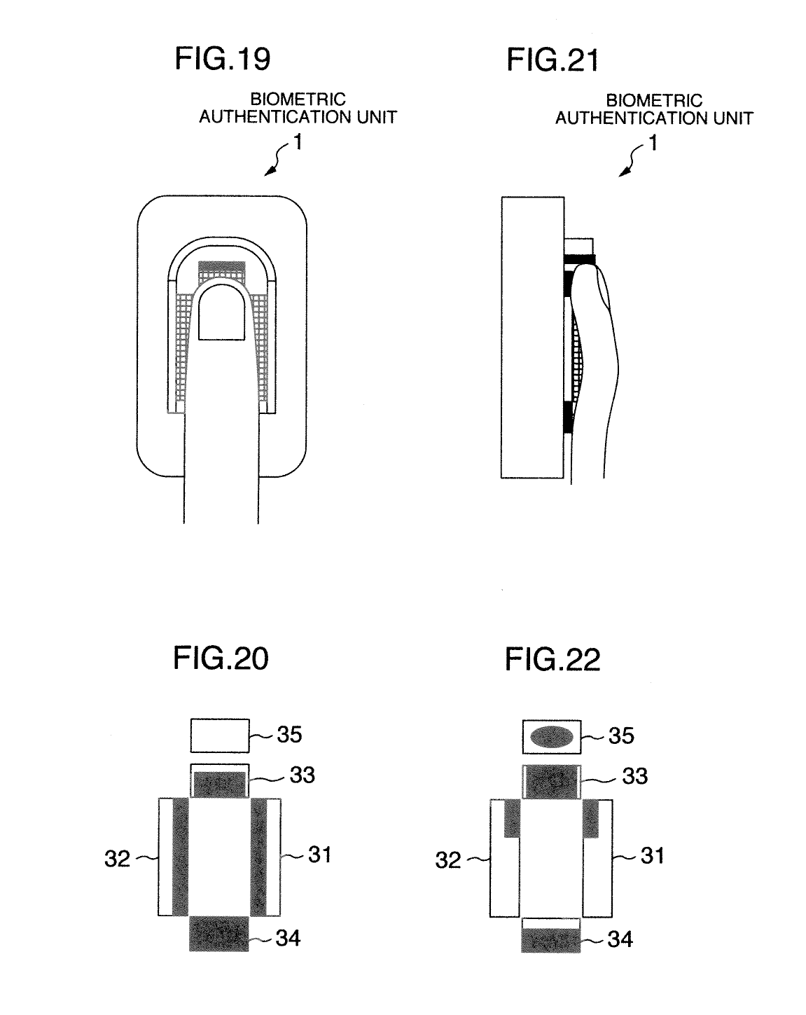

FIG. 20 shows a pressure distribution detected by the right-side pressure detecting plate 31, left-side pressure detecting plate 32, front-side pressure detecting plate 33, rear-side pressure detecting plate 34 and fingertip pressure detecting plate 35, when the user's finger placed on the stage is shifted to the front or rear as shown in FIG. 19.

FIG. 22 shows a pressure distribution detected by the right-side pressure detecting plate 31, left-side pressure detecting plate 32 front-side pressure detecting plate 33, rear-side pressure detecting plate 34 and fingertip pressure detecting plate 35, when the user's finger placed on the stage is bent like an arch as shown in FIG. 21.

As is apparent from the above-mentioned FIG. 5 to FIG. 14, a shift amount to the left or right and a slant amount to the left or right of the user's finger placed on the stage can be estimated from the pressure distribution detected by the right-side pressure detecting plate 31 and left-side pressure detecting plate 32. Specifically, the shift amount to the left or right of the user's finger placed on the stage can be estimated from a difference between a width of the pressure distribution detected by the right-side pressure detecting plate 31 and a width of the pressure detected by the left-side pressure detecting plate 32. The slant amount to the left or right of the user's finger placed on the stage can also be estimated from the slant to the outside of either the pressure distribution detected by the right-side pressure detecting plate 31 or the pressure distribution detected by the left-side pressure detecting plate 32.

In addition, the shift amount to the left or right of the user's finger placed on the stage can also be estimated from the center location of the pressure distribution detected by the fingertip pressure detecting plate 35.

As is apparent from the above-mentioned FIG. 15 to FIG. 18, a rotation amount to the left or right of the user's finger placed on the stage can be estimated from the rotation amount of the (approximately ellipsoidal) pressure distribution detected by the fingertip pressure detecting plate 35.

As is apparent from the above-mentioned FIG. 19 and FIG. 20, the shift amount to the front or rear of the user's finger placed on the stage can also be estimated from the fingertip location in the pressure distribution detected by the front-side pressure detecting plate 33.

In addition, as is apparent from the above-mentioned FIG. 21 and FIG. 22, from the pressure distribution detected by the right-side pressure detecting plate 31 and left-side pressure detecting plate 32, it can be determined that the user's finger placed on the stage is bent like an arch if there is an area where the pressure is not detected in a longitudinal direction.

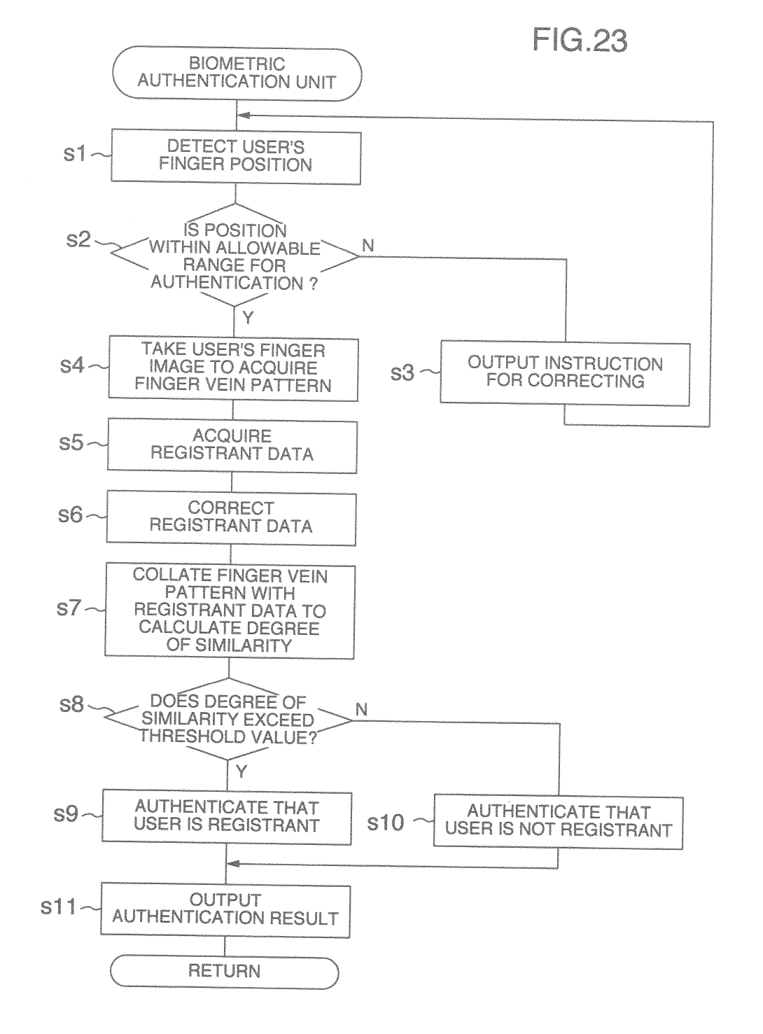

Next, an operation relative to an authentication process of the biometric authentication unit 1 will be described. FIG. 23 is a flowchart showing the authentication process.

In the biometric authentication unit 1, when the user's finger is placed on the stage, a user's finger position is detected (at Step s1). The position detecting section 3 detects the user's finger position (shift amount to the right or left, slant amount to the left or right, rotation amount to the left or right, shift amount to the front or rear, whether the user's finger is bent like an arch, etc.) derived from the pressure distribution detected by the right-side pressure detecting plate 31, left-side pressure detecting plate 32, front-side pressure detecting plate 33, rear-side pressure detecting plate 34 and fingertip pressure detecting plate 35, at Step s1.

In the biometric authentication unit 1, it is determines whether the user's finger position detected by the position detecting section 3 at Step s1 is within an allowable range for authentication (at Step s2). The control section 2 determines whether the difference between the user's finger position on the stage and the correct position is within a predetermined allowable range at Step s2. That is, the control section 2 determines that the user's finger position on the stage is not within the allowable range for authentication if it largely differs from the correct position or if the user's finger is bent like an arch as shown in FIG. 21.

Further, the biometric authentication unit 1 may be configured to determine that the position is not within the allowable range for authentication if the suppress strength detected at the rear-side pressure detecting plate 34 is greater than a predetermined value. Particularly, the biometric authentication unit 1 may determine that the position is not within the allowable range for authentication if the base side of finger presses down on the rear-side pressure detecting plate 34 so strongly as to stem the blood flow of fingertip.

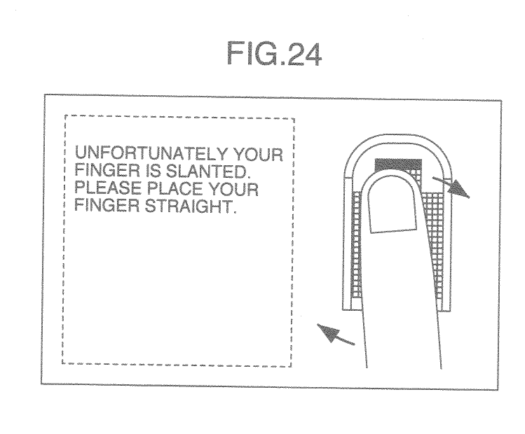

The biometric authentication unit 1 outputs an instruction for correcting the position at Step s3 to bring the process back to the step s1 if it determines that the user's finger position is not within the allowable range for authentication at Step s2. At Step s3, the instruction for correcting the position is input to the high-level device connected with the I/O section 6. The high-level device indicates a correction guide screen on a display in response to the instruction. For example, when the finger is largely slanted, the correction guide screen shown in FIG. 24 is indicated on the display. By means of the indication, the user can simply decide how to move the finger placed on the stage.

When the biometric authentication unit 1 determines that the user's finger position is within the allowable range for authentication at Step s2, the imaging section 5 takes an inner surface image of the user's finger placed on the stage, and the authenticating unit 4 processes the inner surface image of the user's finger to acquire the user's finger vein pattern at Step s4).

The biometric authentication unit 1 acquires the registrant's finger vein pattern (registrant data) from the high-level device (at Step s5). The registrant data is input from the high-level device to the I/O section 6. The authenticating unit 4 corrects the registrant data on the basis of the user's finger position detected at Step s1 (at Step s6). The registrant data is acquired from the image taken by the imaging section 5 under a condition where the user's finger position is substantially correct. At Step s6, the finger vein pattern of registrant data is corrected by shifting to the front or rear, or to the left or right, slanting to the left or right, rotating to the left or right, etc. on the basis of the difference between the user's finger position detected at Step s1 and the correct position.

The authenticating unit 4 collates the user's finger vein pattern acquired at this process with the registrant data corrected at Step s6, to calculate a degree of similarity between them (at step s7). The authenticating unit 4 also authenticates that the user is the registrant if the degree of similarity calculated at Step s7 exceeds a predetermined threshold value (at steps s8 and s9). In contrast, the authenticating unit 4 authenticates that the user is not the registrant if the degree of similarity calculated at Step s7 does not exceed the predetermined value (at steps s8 and s10).

In the biometric authentication unit 1, the I/O section 6 notifies the authentication result to the high-level device (at Step s11).

In this manner, the biometric authentication unit 1 corrects the finger vein pattern of registrant data on the basis of the difference between the user's finger position and the correct position, collates the acquired user's finger vein pattern with the corrected registrant data, and authenticates whether the user is the registrant. This can sufficiently prevent from lowering the accuracy of authenticating an identical person on the basis of the finger vein pattern.

The biometric authentication unit 1 is configured to instruct to correct the user's finger position on the stage when the user's finger position on the stage largely differs from the correct position. This configuration can prevent from taking wasted images and increasing a process time to authenticate whether the user is the registrant.

Although the finger vein pattern of registrant data is corrected on the basis of the difference between the user's finger position and the correct position at Step s6 in the above-mentioned embodiment, the user's finger vein pattern acquired at this process may also be corrected.

Although the above-mentioned example uses the piezoelectric sensor, the biometric authentication unit 1 may be configured to use other types of sensor such as capacitance sensor etc. to detect the user's finger position on the stage.

The biometric authentication unit 1 can also be used to register the registrant data. In this case, biometric information acquired at Step s4 may be registered as registrant data (the process of the above-mentioned step s5 and subsequent steps are unnecessary).

It should be further understood by those skilled in the art that although the foregoing description has been made on embodiments of the invention, the invention is not limited thereto and various changes and modifications may be made without departing from the spirit of the invention and the scope of the appended claims.

1. A biometric authentication unit comprising:
an imaging section for taking through an opening an finger image of a person to be authenticated, the finger being placed opposed to the opening;
a position detecting section for detecting a finger position of the person to be authenticated by a plurality of sensors arranged around the opening, the finger placed being opposed to the opening; and
an authenticating unit for collating, by using the finger position of the person to be authenticated detected by the position detecting section, a finger vein pattern acquired from the finger image of the person to be authenticated taken by the imaging section with a previously registered finger vein pattern of a registrant, to authenticate whether the person to be authenticated is the registrant.

2. The unit according to claim 1 wherein the authenticating unit corrects the finger vein pattern of the registrant by using the finger position of the person to be authenticated detected by the position detecting section; collates the finger vein pattern acquired from the finger image of the person to be authenticated taken by the imaging section with the corrected finger vein pattern of the registrant; and authenticates whether the person to be authenticated is the registrant on the basis of a degree of similarity between them.

3. The unit according to claim 1 further comprising,
a control section for determining on the basis of the finger position of the person to be authenticated detected by the position detecting section whether the finger image of the person to be authenticated taken by the imaging section is inappropriate for the authenticating section that uses the finger image to authenticate whether the person is the registrant, before the imaging section takes through the opening the finger image of the person to be authenticated; and
an I/O section for outputting an instruction for correcting the position when the control section determines that the finger image is inappropriate for the authenticating section that uses the finger image to authenticate whether the person is the registrant.

4. The unit according to claim 2 further comprising,
a control section for determining on the basis of the finger position of the person to be authenticated detected by the position detecting section whether the finger image of the person to be authenticated taken by the imaging section is inappropriate for the authenticating section that uses the finger image to authenticate whether the person is the registrant, before the imaging section takes through the opening the finger image of the person to be authenticated; and
an I/O section for outputting an instruction for correcting the position when the control section determines that the finger image is inappropriate for the authenticating section that uses the finger image to authenticate whether the person is the registrant.

5. The unit according to claim 1 wherein the position detecting section includes pressure detecting plates, each of which is arranged around the opening and has a plurality of piezoelectric sensors arranged in a matrix.

6. The unit according to claim 2 wherein the position detecting section includes pressure detecting plates, each of which is arranged around the opening and has a plurality of piezoelectric sensors arranged in a matrix.

7. The unit according to claim 3 wherein the position detecting section includes pressure detecting plates, each of which is arranged around the opening and has a plurality of piezoelectric sensors arranged in a matrix.

8. The unit according to claim 4 wherein the position detecting section includes pressure detecting plates, each of which is arranged around the opening and has a plurality of piezoelectric sensors arranged in a matrix.
